(19) United States
(12) Patent Application Publication
(10) Pub. No.: US 2010/0138760 A1
(43) Pub. Date: Jun. 3, 2010

(54) METHOD AND SYSTEM FOR PROVIDING AUTO-NAVIGATION OF A SERVICE REGISTRY AND REPOSITORY IN SERVICE-ORIENTED ARCHITECTURE

(75) Inventor: PAMELA K. ISOM, HIGHLANDS RANCH, CO (US)

Correspondence Address: Law Office of Jim Boice, 3839 Bee Cave Road, Suite 201, West Lake Hills, TX, 78746, US

(73) Assignee: INTERNATIONAL BUSINESS MACHINES CORPORATION, Armonk, NY (US)

(21) Appl. No.: 12/326,986

(22) Filed: Dec. 3, 2008

(51) Int. Cl. G06F 3/048

(52) U.S. Cl. 715/764

(57) ABSTRACT

A method, system and computer-readable storage medium are disclosed for providing automatic navigation of a service registry and repository in a service-oriented architecture. The method includes receiving a request from a user to discover a service listed in a service registry and repository of a service-oriented architecture; automatically displaying to the user a description of a service listed in the service registry and repository; and in response to displaying the description of the service, automatically displaying to the user a description of a second service listed in the service registry and repository after a predetermined period of time expires.

### BACKGROUND OF THE INVENTION

1. Technical Field

The present invention relates in general to the field of computers and computer systems, and in particular to service-oriented architectures.

2. Description of the Related Art

Companies have long sought to integrate existing systems in order to implement information technology (IT) support for business processes that cover all present and prospective systems requirements needed to run the business end-to-end. A flexible, standardized architecture is required to better support the connection of various applications and the sharing of data. Service-Oriented Architecture is one such architecture.

Service-Oriented Architecture (SOA) is an architectural style that guides all aspects of creating and using business processes, packaged as services, throughout their lifecycle, as well as defining and provisioning the IT infrastructure that allows different applications to exchange data and participate in business processes loosely coupled from the operating systems and programming languages underlying those applications. SOA represents a model in which functionality is decomposed into small, distinct units which can be distributed over a network and can be combined together and reused to create business applications. These services communicate with each other by passing data from one service to another, or by coordinating an activity between two or more services.

An SOA unifies business processes by structuring large applications as an ad-hoc collection of smaller modules called services. These applications can be used by different groups of people both inside and outside the company, and new applications built from a mix of services from the global pool exhibit greater flexibility and uniformity. A user should not, for example, have to redundantly provide the same personal information to open an online checking, savings or IRA account. Furthermore, the interfaces with which the user interacts should have the same look and feel and use the same level and type of input data validation. Building all applications from the same pool of services makes achieving this goal much easier and more deployable to affiliate companies. For example, a user might be interacting with a rental car company's reservation system even though the user is doing so from an airline reservation system.

An SOA builds applications out of software services. Services are relatively large, intrinsically unassociated units of functionality which have no calls to each other embedded within them. They typically implement functionalities most humans would recognize as a service, such as filling out an online application for an account, viewing an online bank statement, or placing an online booking or airline ticket order. Instead of services embedding calls to each other in their source code, protocols are defined which describe how one or more services can talk to each other. This architecture then relies on a business process expert to link and sequence services to meet a new or existing business system requirement.

A service registry and repository (such as Websphere® Service Registry and Repository by IBM Corporation) handles the management of service descriptions and serves as the system of record for this information throughout the complete lifecycle of a service. The service registry and repository is used to find, publish, manage and subscribe to services with the assurance that the underlying policies associated with correct usages of these services are enforced and governed. The service registry and repository provides a standard, interoperable means to access, query and manipulate the service descriptions. The service registry and repository acts as a listing of the services available and the addresses for invoking them.

When a service consumer has a need to invoke a service provided by a service provider, the service consumer attempts to discover an appropriate service from a service registry. Typically, the service consumer is presented with a list of the services provided by the service provider. The service consumer must manually navigate through the list of services to find an appropriate service. For large service registries, the manual navigation requires a significant amount of user interaction with an input device (such as mouse “clicking”) to view the service descriptions. The manual navigation can be cumbersome and irritating to the user.

### BRIEF SUMMARY OF THE INVENTION

The present invention provides a method, system and computer-readable medium for providing automatic navigation of a service registry and repository in a service-oriented architecture. The method includes receiving a request from a user to discover a service listed in a service registry and repository of a service-oriented architecture; automatically displaying to the user a description of a service listed in the service registry and repository; and in response to displaying the description of the service, automatically displaying to the user a description of a second service listed in the service registry and repository after a predetermined period of time expires.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a block diagram of an exemplary data processing system in which one or more embodiments of present invention may be implemented;

FIG. 2 shows a block diagram of an exemplary service-oriented architecture in which one or more embodiments of the present invention can be implemented;

FIG. 3 is a block diagram of a prior art service registry and repository interface;

FIGS. 4A-4B are block diagrams of a service registry and repository interface with automatic navigation in accordance one or more embodiments of the present invention; and

FIG. 5 is a flowchart depicting an exemplary process for providing auto-navigation of a service registry and repository in accordance with one or more embodiments of the present invention.

### DETAILED DESCRIPTION OF THE INVENTION

An illustrative embodiment of the present invention directed to a method, system and computer-readable medium is described in detail for providing automatic navigation of a service registry in a service-oriented architecture. The present invention can take the form of an entirely hardware embodiment, an entirely software embodiment or an embodiment containing both hardware and software elements. In an illustrative embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, a removable computer diskette, a random access memory (RAM), a read-only memory (ROM), a rigid magnetic disk (e.g., a hard drive) and an optical disk. Current examples of optical disks include compact disk-read only memory (CD-ROM), compact disk-read/write (CD-R/W) and Digital Versatile Disk (DVD).

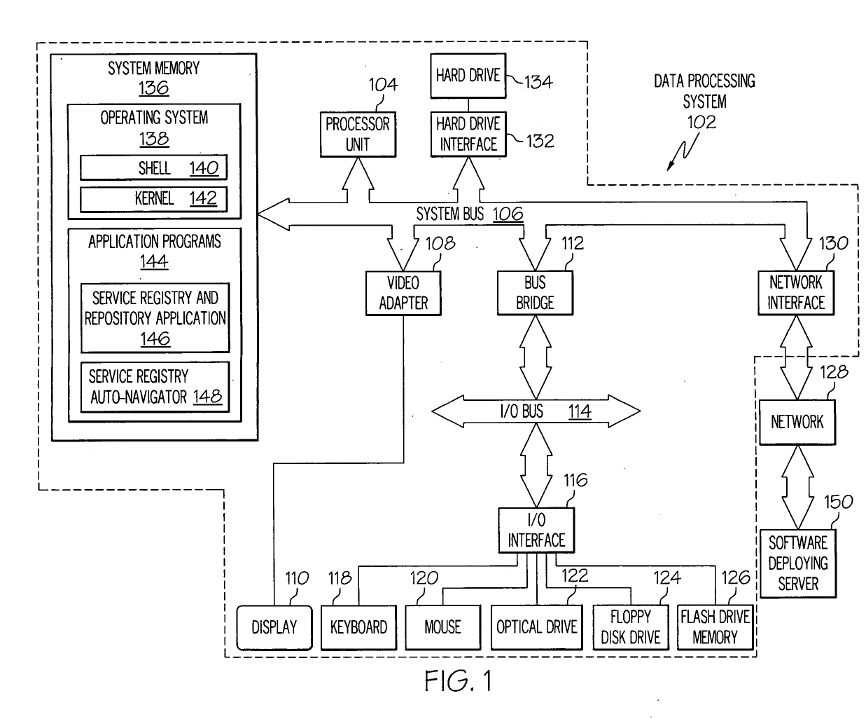

Referring now to the drawings, wherein like numbers denote like parts throughout the several views, FIG. 1 shows a block diagram of a data processing system suitable for storing and/or executing program code in accordance with one or more embodiments of the present invention. The hardware elements depicted in data processing system 102 are not intended to be exhaustive, but rather are representative of one embodiment of the present invention. Data processing system 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, an optical disk drive 122, a floppy disk drive 124, and a flash drive memory 126. The format of the ports connected to I/O interface 116 may be any known to those skilled in the art of computer architecture, including but not limited to Universal Serial Bus (USB) ports.

Data processing system 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Software deploying server 150 may utilize a similar architecture design as that described for data processing system 102.

A hard drive interface 132 is also coupled to system bus 106. Hard drive interface 132 interfaces with hard drive 134. In an illustrative embodiment, hard drive 134 populates a system memory 136, which is also coupled to system bus 106. Data that populates system memory 136 includes an operating system (OS) 138 of data processing system 102, application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 in the system memory of data processing system 102 include service registry and repository application 146. Service registry and repository application 146 includes program modules and instructions enabling a service provider to publish and manage the lifecycle of services in a service-oriented architecture. Application programs 144 also include service registry auto-navigator 148. Service registry auto-navigator 148 enables a service customer to automatically browse the services available in a service registry in accordance with one or more embodiments of the present invention and is describe in further detail herein.

The hardware elements depicted in data processing system 102 are not intended to be exhaustive, but rather are representative to highlight essential components required by the present invention. For instance, data processing system 102 may include alternate memory storage devices such as magnetic cassettes, Digital Versatile Disks (DVDs), Bernoulli cartridges, and the like. These and other variations are intended to be within the spirit and scope of the present invention.

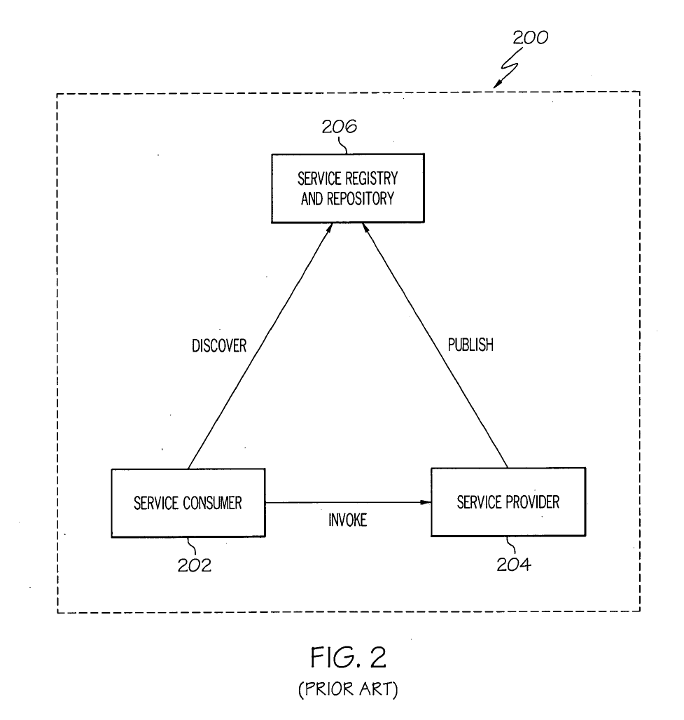

FIG. 2 shows a block diagram of an exemplary service oriented architecture in which one or more embodiments of the present invention can be implemented. Service oriented architecture (SOA) 200 includes a service provider 204. Service provider 204 creates a service for performing a business function. For example, service provider 204 may be an airline company publishing a service to book a flight reservation. Service provider 204 publishes an interface to the service and information to access the service to service registry and repository 206. Service registry and repository 206 handles the management of service descriptions and serves as the system of record for this information. A populated and maintained service registry and repository is the place in an organization that catalogs the services deployed or used by service provider 204. Service registry and repository 206 makes the service interface and implementation access information available to service consumer 202, for example, a travel agency. Service registry and repository 206 is a searchable registry of service descriptions where service provider 204 publishes service descriptions. Service customer 202 discovers services and obtains binding information (in the service descriptions) for services during development for static binding, or during execution for dynamic binding. For example, there are public service registries available over the Internet to an unrestricted audience, as well as private service registries that are only accessible to users within a company-wide intranet. When service customer 202 is ready to use a service, service customer 202 invokes the service using the access information provided by service registry and repository 206.

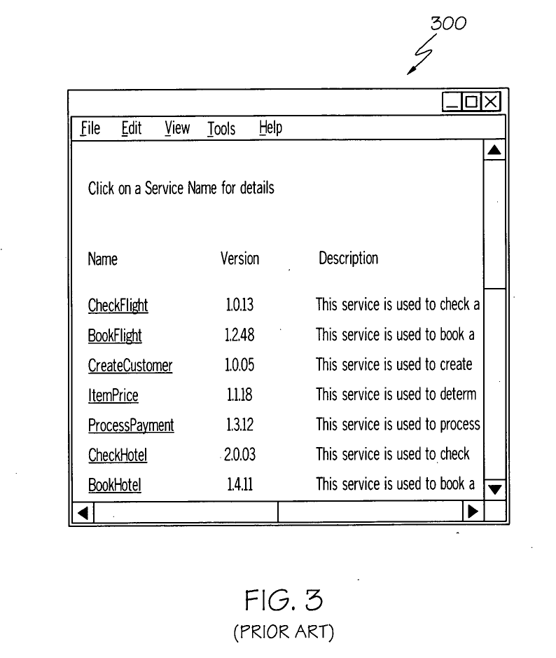

FIG. 3 is a block diagram of a prior art service registry and repository interface. Service registry and repository interface 300 displays to service customer 202 a list of services available from service provider 204. Service customer 202 must manually select each service for which service customer 202 would like to see a more detailed description. For a large service registry and repository, this task of manually selecting each service to see a more detailed description is very time consuming and requires a large amount of user input.

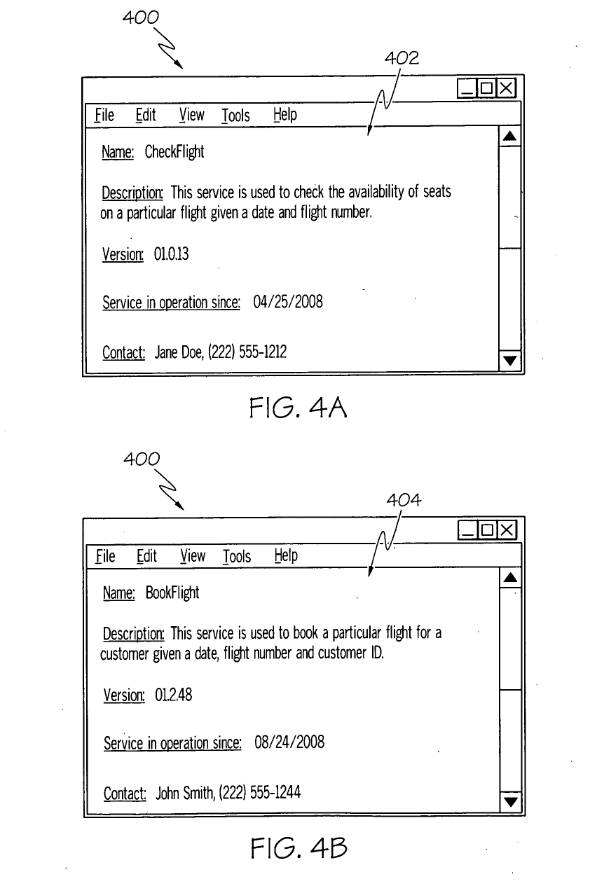

FIG. 4A is a block diagram of a service registry and repository interface 400 with automatic navigation in accordance with one or more embodiments of the present invention. Upon a request from service customer 202, service registry and repository application 146 automatically displays to service customer 202 detailed description 402 corresponding to the first service of a number of services that are returned in response to the request of the service customer 202. For example, if service customer 202 is a travel agency, then service customer 202 may want to see any services related to air travel that may be available from service provider 204. Service registry and repository application 146 automatically displays detailed description 402 corresponding to the “CheckFlight” service. The service customer is not required to manually select the “CheckFlight” service from a list. As depicted in FIG. 4B, after a predetermined amount of time, service registry and repository application 146 automatically displays to service customer 202 detailed description 404 corresponding to the second service of a number of services that are returned in response to the request of the service customer 202. For example, after 10 seconds service registry and repository application 146 automatically displays detailed description 404 corresponding to the “BookFlight” service. Service registry and repository application 146 continues to automatically display, after the predetermined amount of time, the detailed descriptions of each service returned in response to the request of the service customer 202. Service customer 202 can customize service registry and repository interface 400 to display the specific information that is of interest to the service customer 202. For example, service customer 202 may want to see the name of the service, the version number of the service, the date the service first became operational, a technical contact at service provider 204, etc. Service customer 202 can elect to see a preview of features of the service. Service customer 202 can also set the predetermined time delay between the displays of detailed descriptions.

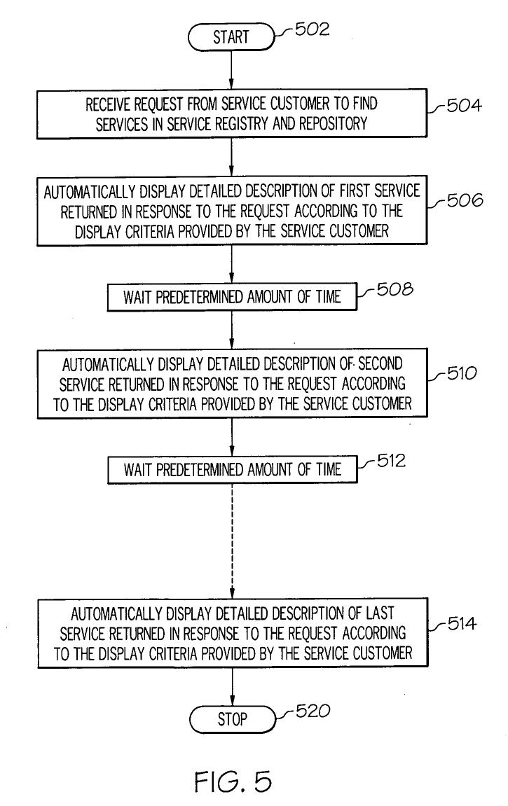

FIG. 5 is a flowchart depicting an exemplary process for providing auto-navigation of a service registry and repository in accordance with one or more embodiments of the present invention. The process begins at initiator 502. Service registry and repository application 146 receives a request from service customer 202 to find services in service registry and repository 206 (step 504). Service registry and repository application 146 automatically displays a detailed description of the first service returned in response to the request according to any display criteria provided by service customer 202 (step 506). Default display criteria are used where the service customer indicates no preference. Service registry and repository application 146 waits a predetermined amount of time (step 508). In response to waiting the predetermined amount of time, service registry and repository application 146 automatically displays a detailed description of the second service returned in response to the request of service customer 202 (step 510). Service registry and repository application 146 waits a predetermined amount of time (step 512). As shown in FIG. 5, the dashed line connecting steps 512 and 514 is indicative of the fact that steps 510-512 reiterate in a recursive manner until service registry and repository application 146 automatically displays a detailed description of the last service returned in response to the request of service customer 202 (step 514) or until the service customer provides an input to escape the process. The process ends at terminator 520.

By automatically navigating and displaying services in accordance with the present invention, service customer 202 is able to browse and/or preview service capabilities in a real-time manner with less end-user interaction. This enables service customer 202 to multitask and eliminates keystrokes, while also enabling service customer 202 to preview services that may have been bypassed due to user oversight and/or error. This invention can be used in conjunction with service registry components like universal description discovery and integration (UDDI).

While the present invention has been particularly shown and described with reference to an illustrative embodiment, it will be understood by those skilled in the art that various changes in form and detail may be made therein without departing from the spirit and scope of the invention. Furthermore, as used in the specification and the appended claims, the term “computer” or “computer system” or “computing device” includes any data processing system including, but not limited to, personal computers, servers, workstations, network computers, mainframe computers, routers, switches, Personal Digital Assistants (PDA's), telephones, and any other system capable of processing, transmitting, receiving, capturing and/or storing data. The term “system” or “information system” includes a network of data processing systems.

The flowchart and diagrams in the Figures illustrate the architecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to illustrative embodiments thereof, it will be apparent that modifications and variations are possible without departing from the scope of the invention defined in the appended claims.

What is claimed is:

1. A computer-implemented method in a data processing system comprising:
receiving a request from a user to discover a service listed in a service registry and repository of a service-oriented architecture;
automatically displaying to said user a description of a first service listed in said service registry and repository; and
in response to displaying said description of said first service, automatically displaying to said user a description of a second service listed in said service registry and repository after a predetermined period of time expires.

2. The computer-implemented method of claim 1, wherein said predetermined period of time is determined by said user.

3. The computer-implemented method of claim 1, wherein said description is displayed in accordance with display criteria provided by said user.

4. The computer-implemented method of claim 3, wherein said display criteria includes an indication of the time said service has been in operation.

5. The computer-implemented method of claim 3, wherein said display criteria includes a functional preview of said service.

6. A data processing system comprising:
a processor;
a memory coupled to said processor;
a service registry and repository application populating said memory, wherein said service registry and repository application populating said memory comprises computer-executable instructions for:
receiving a request from a user to discover a service listed in a service registry and repository of a service-oriented architecture;
automatically displaying to said user a description of a first service listed in said service registry and repository; and
in response to displaying said description of said first service, automatically displaying to said user a description of a second service listed in said service registry and repository after a predetermined period of time expires.

7. The system of claim 6, wherein said predetermined period of time is determined by said user.

8. The system of claim 6, wherein said description is displayed in accordance with display criteria provided by said user.

9. The system of claim 8, wherein said display criteria includes an indication of the time said service has been in operation.

10. The system of claim 8, wherein said display criteria includes a functional preview of said service.

11. A computer-readable storage medium encoded with a computer program that, when executed by a data processing system, causes said data processing system to perform the steps of:
receiving a request from a user to discover a service listed in a service registry and repository of a service-oriented architecture;
automatically displaying to said user a description of a first service listed in said service registry and repository; and
in response to displaying said description of said first service, automatically displaying to said user a description of a second service listed in said service registry and repository after a predetermined period of time expires.

12. The computer-readable storage medium of claim 10, wherein said predetermined period of time is determined by said user.

13. The computer-readable storage medium of claim 10, wherein said description is displayed in accordance with display criteria provided by said user.

14. The computer-readable storage medium of claim 13, wherein said display criteria includes an indication of the time said service has been in operation.

15. The computer-readable storage medium of claim 13, wherein said display criteria includes a functional preview of said service.
